(19) United States
(12) Patent Application Publication
(10) Pub. No.: US 2020/0016751 A1
(43) Pub. Date: Jan. 16, 2020

(54) MOBILE ROBOT FOR AVOIDING NON-DRIVING AREA AND METHOD FOR AVOIDING NON-DRIVING AREA OF MOBILE ROBOT

(71) Applicant: LG ELECTRONICS INC., Seoul (KR)

(72) Inventors: Tae Yeon PARK, Incheon (KR); Dae Sung KIM, Yongin-si (KR)

(73) Assignee: LG ELECTRONICS INC., Seoul (KR)

(21) Appl. No.: 16/579,016

(22) Filed: Sep. 23, 2019

(30) Foreign Application Priority Data
Aug. 22, 2019 (KR) 10-2019-0103047

(51) Int. Cl. B25J 9/16; B25J 11/00; B25J 19/02

(52) U.S. Cl. CPC B25J 9/1666; B25J 11/0085; A47L 9/2826; B25J 9/1676; B25J 19/027

(57) ABSTRACT

According to the present disclosure, when a mobile robot travels, if the learning information of the avoiding mark which is machine-trained by the mobile robot corresponds to a mark around the target object sensed by the mobile robot, the mobile robot can avoid the sensed avoiding mark. That is, the mobile robot may collide with an object which needs to be avoided while traveling. Therefore, when an avoiding mark which is formed of at least any one of a different color or a different material from the floor of the driving area is disposed around an object to be avoided or an area to be avoided and the avoiding mark is sensed, the mobile robot autonomously avoids the object or the area to be avoided to be prevented from colliding with the object which needs to be avoided or traveling in the area to be avoided.

### CROSS-REFERENCE TO RELATED APPLICATION

This present application claims benefit of priority to Korean Patent Application No. 10-2019-0103047, entitled “MOBILE ROBOT FOR AVOIDING NON-DRIVING AREA AND METHOD FOR AVOIDING NON-DRIVING AREA OF MOBILE ROBOT,” filed on Aug. 22, 2019, in the Korean Intellectual Property Office, the entire disclosure of which is incorporated herein by reference.

### BACKGROUND

### 1. Technical Field

The present disclosure relates to an autonomous mobile robot which learns an avoiding mark disposed in a non-driving area to avoid the non-driving area and a method for avoiding a non-driving area of a mobile robot, and more particularly, to a technique that after learning information about an avoiding mark disposed in a non-driving area, a mobile robot senses the mark disposed in a driving area and when the sensed mark matches the learned information, travels while avoiding the avoiding mark.

### 2. Description of the Related Art

The following description is only for the purpose of providing background information related to embodiments of the present disclosure, and the contents to be described do not necessarily constitute related art.

Robots have been developed for industrial use and were partially responsible for factory automation. In recent years, the field of applications for robots has been further expanded to, for example, medical robots and aerospace robots. In addition, household robots that may be used in ordinary homes are being developed. Among these robots, a robot capable of autonomously moving is called a mobile robot.

A cleaning robot is a device that sucks dust or foreign materials from a target region to be cleaned while autonomously traveling around the target region, thereby cleaning the target region.

Such a mobile robot can sense a distance from an obstacle such as furniture or a wall of stationery disposed in a cleaning region and perform an operation of avoiding the obstacle.

However, even though the mobile robot senses the obstacle, when the mobile robot approaches the obstacle to clean and then changes a route or moves to another route, interference with the obstacle occurs, which may cause a damage of the obstacle. Further, in some cases, after entering a predetermined area, the mobile robot cannot get out of the region.

To this end, when the cleaning region of the mobile robot is set, a method of preventing the mobile robot from approaching a partial area of the cleaning area is being sought.

Specifically, a device which generates a predetermined signal to prevent the mobile robot from accessing an area to which the mobile robot should not access may be installed. However, when the device which generates a signal is used, there is a problem in that the mobile robot cannot exactly figure out a position and a size of an area where the signal is generated.

Further, a virtual wall is installed in an area to which the mobile robot should not access, and a driving area is cleaned by the mobile robot using an external device which has a function of setting a virtual wall.

Specifically, after generating a map of the driving area, a non-driving area of the mobile robot is set on the map to be cleaned by the mobile robot. For example, in Korean Unexamined Patent Application Publication No. 10-2014-0087486, “Method for generating a moving passage of a mobile robot using a virtual wall layer” which receives and uses virtual wall information about an obstacle which is additionally generated on a robot map in advance from a manager who manages the robot is disclosed.

However, according to the “Method for generating a moving passage of a mobile robot using a virtual wall layer”, in order to prevent the collision with the obstacle, the manager needs to input the virtual wall information in advance. That is, a technology that sets a non-driving area during the setting of the map when the non-driving area is set is not disclosed.

Further, in Korean Registered Patent No. 10-0794409, “a mobile robot and a method for calculating a position and a posture thereof” discloses a technology which uses a marker including a light emitting diode to calculate a position and a posture of a mobile robot in a moving area.

However, according to “the mobile robot and the method for calculating a position and a posture thereof”, a light emitting interval or a light emitting order of a plurality of light emitting diodes in a marker is used as identification data of a marker, so that the markers need to include light emitting diodes. Therefore, the cost is increased, the light emitting interval and order need to be exactly controlled, and a risk of recognition error may be significant.

Therefore, a technique which sets a non-driving area while the mobile robot travels and allows the mobile robot to travel while avoiding the set non-driving area is necessary.

The above-described background technology is technical information that the inventors hold for the derivation of the present disclosure or that the inventors acquired in the process of deriving the present disclosure. Thus, the above-described background technology cannot be regarded as known technology disclosed to the general public prior to the filing of the present application.

### RELATED ART DOCUMENT

### [Patent Document]

Related Art 1: Korean Unexamined Patent Application Publication No. 10-2014-0087486 (published on Jul. 9, 2014)

Related Art 2: Korean Registered Patent No. 10-0794409 (registered on Jan. 7, 2008)

### SUMMARY OF THE INVENTION

An object of the present disclosure is to allow a mobile robot to avoid a non-driving area where the mobile robot should not travel.

Another object of the present disclosure is to learn a mark representing a non-driving area of a mobile robot, and then sense the mark while the mobile robot travels and allow the mobile robot to avoid the mark based on data obtained by learning the sensed mark.

Further, still another object of the present disclosure is to learn an avoiding mark representing a non-driving area of a mobile robot, store a position of the avoiding mark in map data, and then determine whether a sensed avoiding mark is stored in the map data and if the sensed avoiding mark is stored in the map data, avoid the avoiding mark.

The objective of the present disclosure is not limited to the above-mentioned objectives and other objectives and aspects of the present disclosure which are not mentioned can be understood by the following description, and will be more clearly understood by the embodiments of the present disclosure. It is also to be understood that the aspects of the present disclosure may be realized by means and combinations thereof set forth in claims.

To achieve the above-described objects, a technology which does not allow the mobile robot to travel in a non-driving area where the mobile robot should not travel and generates the non-driving area is provided.

Specifically, a method for generating a non-driving area of a mobile robot according to an embodiment of the present disclosure performs cleaning and map generation while moving an indoor space, senses an avoiding mark, recognizes a region represented by the avoiding mark as a non-driving area to avoid, and then reflects the region represented by the avoiding mark to the map as a non-driving area.

In this case, when the avoiding mark is sensed, the mark is determined as an avoiding mark through an avoiding mark reading program which is stored in advance.

Specifically, according to the method for generating a non-driving area of a mobile robot according to an embodiment of the present disclosure, when the avoiding mark is sensed, a predetermined electromagnetic wave is radiated toward a sensed mark, an electromagnetic wave reflected by the mark is measured, and then it is determined whether the mark is an avoiding mark based on the measurement of the reflected electromagnetic.

In this case, when it is determined whether the mark is an avoiding mark, the electromagnetic wave reflected from the mark is analyzed and when it is determined that the mark has at least any one property of a different color or a different material from another driving area of the indoor space, the mark is determined as the avoiding mark.

Further, according to a method for generating a non-driving area of a mobile robot according to an embodiment of the present disclosure, before the performing of cleaning and map generation, after receiving learning data which receives a learning data set including a specific image and a label indicating that the specific image is an avoiding mark, a machine learning model for determining whether the mark sensed during the traveling of the mobile robot is an avoiding mark is trained and the machine learning model generated in the training step is stored as an avoiding mark reading program.

That is, in a state when the mobile robot learns information about an avoiding mark, the avoiding mark which is implemented with a different color and a different material from those of the driving area is disposed around a target object and when the mobile robot senses the mark during the traveling, the mobile robot can travel while avoiding the vicinity of the mark.

Further, according to a method for generating a non-driving area of a mobile robot according to an embodiment of the present disclosure, when the region represented by the avoiding mark is recognized as a non-driving area to be avoided, the region represented by the avoiding mark is recognized as a virtual wall.

Specifically, the region represented by the avoiding mark is reflected to the map as a virtual wall. That is, when the avoiding mark is avoided, the region represented by the avoiding mark is recognized as a virtual wall and the region represented by the avoiding mark is reflected to the map as a virtual wall. Therefore, the mobile robot cannot move by passing the avoiding mark due to the virtual wall.

Further, according to a method for generating a non-driving area of a mobile robot according to an embodiment of the present disclosure, after reflecting the region represented by the avoiding mark to the map as a virtual wall, a cleaning route may be generated based on the map to which the non-driving area is reflected.

Specifically, after reflecting the region represented by the avoiding mark to the map as a virtual wall, the map of the indoor space to which the non-driving area is reflected is transmitted to the user terminal, and then a user confirmation signal for the map of the indoor space is received and the map of the indoor space is stored based on the user confirmation signal.

In the meantime, according to an embodiment of the present disclosure, a mobile robot which travels avoiding a non-driving area includes a main body of the mobile robot; a driver configured to drive the main body; a sensor equipped in the main body, the sensor sensing a generated avoiding mark while moving an indoor space; a memory configured to store map data of a space where the mobile robot travels; and a controller configured to control the memory, the driver, the sensor, and the mobile robot.

In this case, the controller is configured to determine whether a target sensed by the sensor is an avoiding mark through an avoiding mark reading program which is stored in advance and when the sensed target is the avoiding mark, recognize the region represented by the avoiding mark as a non-driving area and control the driver to travel while avoiding the non-driving area, and reflect the region represented by the avoiding mark to the map data as a non-driving area.

Specifically, the sensor of the mobile robot according to the embodiment of the present disclosure may radiate a predetermined electromagnetic wave toward the sensed mark. In this case, the controller measures an electromagnetic wave reflected by the mark and determines whether the mark is an avoiding mark based on measurement of the reflected electromagnetic wave.

Specifically, the controller analyzes the electromagnetic wave reflected from the mark and determines the mark as the avoiding mark when it is determined that the mark has at least any one property of a different color or a different material from those of another driving area of the indoor space.

Further, the controller of the mobile robot according to the embodiment of the present disclosure trains a machine learning model for determining whether the target sensed during the traveling of the mobile robot is an avoiding mark based on a learning data set input by including a specific image and a label indicating that the specific image is an avoiding mark and stores the trained machine learning model in the memory as an avoiding mark reading program.

That is, in a state when the mobile robot learns information on an avoiding mark, the avoiding mark which is implemented with a different color and a different material from those of the driving area is disposed around a target object and when the mobile robot senses the mark during the traveling, the mobile robot can travel while avoiding the mark.

Further, the controller of the mobile robot according to the embodiment of the present disclosure is configured to recognize the region represented by the avoiding mark as a virtual wall and reflect the region represented by the avoiding mark as a virtual wall in the map data stored in the memory.

Specifically, the region represented by the avoiding mark is reflected to the map as a virtual wall. That is, when the avoiding mark is avoided, the region represented by the avoiding mark is recognized as a virtual wall and the region represented by the avoiding mark is reflected to the map as a virtual wall. Therefore, the mobile robot cannot move by passing the avoiding mark due to the virtual wall.

Other aspects and features than those described above will become apparent from the following drawings, claims, and detailed description of the present disclosure.

According to the present disclosure, in a state when the mobile robot learns information on an avoiding mark, the avoiding mark which is implemented with a different color and a different material from those of the driving area is disposed around a target object and when the mobile robot senses the mark during the traveling, the mobile robot can travel while avoiding the vicinity of the mark.

Specifically, as the avoiding mark is implemented by a material such as a tape, the avoiding mark can be easily installed in the non-driving area where the mobile robot should not travel and the mobile robot can travel while avoiding the non-driving area by the avoiding mark, so that the mobile robot can travel while avoiding an object, a banister, or a cliff which needs to be avoided.

Further, when the target object needs to be avoided, the mobile robot travels while avoiding the target object so that the damage of the mobile robot may be? caused when the mobile robot travels toward an object which needs to avoid the collision or moves to an area to which the mobile robot cannot move may be prevented.

Further, according to the present disclosure, even though an avoiding mark position where the avoiding mark is disposed is not stored in the map data, the mobile robot which senses the avoiding mark can avoid the avoiding mark. Therefore, when it is necessary to set a non-driving area, even though the mark is not stored in the map data, the area is immediately marked to be set as a non-driving area.

Specifically, there is no need to install a separate product in the driving area as an avoiding mark, but the avoiding mark is disposed in an area to be avoided to allow the mobile robot to avoid.

The effects of the present disclosure are not limited to the effects mentioned above, and other effects not mentioned may be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a view illustrating an embodiment in which a mobile robot which avoids an avoiding mark according to an embodiment of the present disclosure is implemented;

FIG. 2 is a schematic block diagram of a mobile robot according to an embodiment of the present disclosure;

FIG. 3 is a view illustrating an embodiment in which a mobile robot according to an embodiment of the present disclosure senses an avoiding mark while traveling along a driving area to avoid the avoiding mark;

FIGS. 4 and 5 are views schematically illustrating a process of sensing and avoiding an avoiding mark by a mobile robot according to an embodiment of the present disclosure;

FIG. 6 illustrates an example in which when different avoiding marks are spaced apart from each other while a mobile robot according to an embodiment of the present disclosure avoids the avoiding mark, the mobile robot avoids the avoiding mark or passes between the avoiding marks; and

FIG. 7 is a flowchart illustrating of a process of learning an avoiding mark and avoiding the learned avoiding mark by a mobile robot according to an embodiment of the present disclosure.

### DETAILED DESCRIPTION

Hereinafter, the present disclosure will be described in more detail with reference to the drawings. The present disclosure may be embodied in various different forms and is not limited to the embodiments set forth herein. Hereinafter in order to clearly describe the present disclosure, parts that are not directly related to the description are omitted. However, in implementing an apparatus or a system to which the spirit of the present disclosure is applied, it is not meant that such an omitted configuration is unnecessary. In addition, like reference numerals are used for like or similar components throughout the specification.

In the following description, although the terms “first”, “second”, and the like may be used herein to describe various elements, these elements should not be limited by these terms. These terms may be only used to distinguish one element from another element. Also, in the following description, the articles “a,” “an,” and “the,” include plural referents unless the context clearly dictates otherwise.

In the following description, it will be understood that terms such as “comprise,” “include,” “have,” and the like are intended to specify the presence of stated feature, integer, step, operation, component, part or combination thereof, but do not preclude the presence or addition of one or more other features, integers, steps, operations, components, parts or combinations thereof.

Hereinafter, a mobile robot which autonomously travels while avoiding an avoiding mark of the present disclosure will be described in more detail with reference to the drawings.

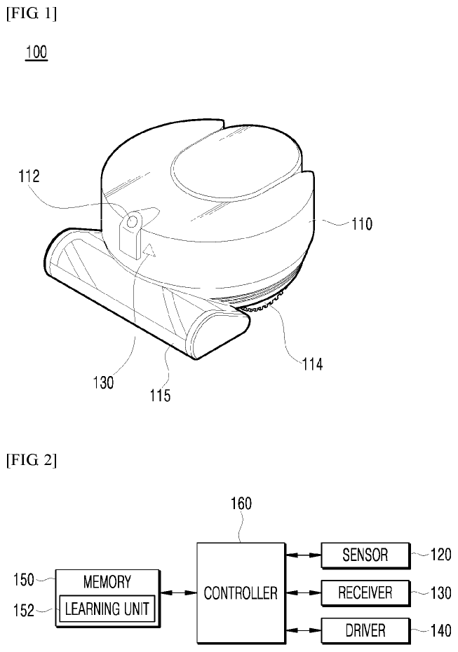

FIG. 1 is a view illustrating an embodiment in which a mobile robot which avoids an avoiding mark according to an embodiment of the present disclosure is implemented and FIG. 2 is a schematic block diagram of a mobile robot according to an embodiment of the present disclosure.

Although as a mobile robot according to the embodiment of the present disclosure, an autonomous cleaning robot will be described, the mobile robot may be operated in a semi-autonomous mode or a manual mode as well as the autonomous mode. In addition, the mobile robot capable of machine learning and autonomous moving according to an embodiment of the present disclosure may be any one of robots that may be operated in autonomous or semi-autonomous modes in addition to a cleaning robot.

The mobile robot 100 according to the embodiment of the present disclosure includes a main body 110, a driver 140, and a sensor 120.

Specifically, the main body 110 includes an image acquirer 112 which acquires an image around the mobile robot 100 when the mobile robot 100 travels. The image acquirer 112 photographs an indoor space and includes a camera. Each camera may include an image sensor (for example, a CMOS image sensor) which includes at least one optical lens and a plurality of photodiodes (for example, pixels) forming an image using the light passed through the optical lens, and may include a digital signal processor (DSP) for forming an image based on signals outputted from the photodiodes. The digital signal processor may generate not only a still image, but also a moving image formed of frames configured by still images.

Further, the main body 110 includes a sucker 115 which sucks suctionable foreign materials or dust while the mobile robot 100 travels. The main body 110 further includes a dust collector (not illustrated) which collects foreign materials or dust sucked through a suction device (not illustrated) or the sucker 115 so as to allow the sucker 115 to suck the foreign materials or dust.

Further, the main body 110 may further include a battery (not illustrated). The battery may supply power required for overall operations of the mobile robot 100 in addition to the driver 150 to be described below. A charging dock (not illustrated) which charges the battery when the battery is discharged may be installed in a moving space of the mobile robot 100 and the mobile robot 100 may be configured to return to the charging dock at an appropriate timing and detect a position of the charging dock by itself while traveling to return to the charging dock, simultaneously.

To this end, the charging dock may include a signal transmitter (not illustrated) which transmits a predetermined returning signal. The returning signal may be an ultrasonic signal or an infrared signal but is not limited thereto.

With regard to this, the mobile robot 100 includes a signal sensor (not illustrated) which receives the returning signal. That is, the charging dock transmits the returning signal through the signal transmitter, the mobile robot 100 moves to the charging dock in accordance with the returning signal sensed by the signal sensor, and the mobile robot 100 which moves to the charging dock docks with the charging dock to be charged.

The driver 140 includes at least one driving wheel 114 which moves the main body 110. The driver 140 may further include a driving motor (not illustrated) which is connected to the driving wheel 114 to rotate the driving wheel 114. Further, the driving wheels 114 are installed at a left side and a right side of the main body 110 to allow the main body 110 to be stably driven.

The sensor 120 may sense a target object located in front of the mobile robot 100 while the mobile robot 100 travels the indoor space. The target object may refer to an obstacle such as an object disposed in the indoor space where the mobile robot 100 travels, a sill installed to distinguish passages through which the mobile robot 100 moves, and a cliff region on a floor in the indoor space.

Further, the sensor 120 may radiate a predetermined electromagnetic wave to a mark disposed around the target object. The electromagnetic wave may be any one of an infrared sensor or a laser sensor, but the present disclosure is not limited to a type of radiated wavelength.

Specifically, the sensor 120 radiates a laser to the mark disposed around the target object. When the mark disposed around the target object is formed of a different color and a different material from those of the indoor space, a returning electromagnetic wave time of the laser which is radiated toward the indoor space to return to the sensor 120 and a returning electromagnetic wave time which is radiated to the mark disposed around the target object to return may be different.

Specifically, when the returning electromagnetic time which is radiated to the mark disposed around the target object to return and the returning electromagnetic wave time which is radiated toward an avoiding mark 200 stored in the memory 150 to be described below to return to the sensor 120 are the same, it can be determined that the mark disposed around the target object is an avoiding mark which needs to be avoided by the mobile robot 100. The information about the avoiding mark 200 is stored in the memory 150 and the memory 150 will be described below in more detail.

In the meantime, the mobile robot 100 may further include a controller 160 which controls the traveling of the mobile robot 100 so as not to collide with the target object sensed by the sensor 120 or to avoid the sill or cliff area, and the memory 150 in which various data required to control the traveling of the mobile robot 100 is stored.

Specifically, the controller 160 may control the main body 110 which configures the mobile robot 100 and the driver 140 so that the overall operation of the mobile robot 100 may be controlled.

Further, the memory 150 records various information required to control the mobile robot 100 and includes a volatile or non-volatile recording medium. The recording medium is configured to store data readable by the controller 190, and may include a hard disk drive (HDD), solid state disk (SSD), silicon disk drive (SDD), ROM, RAM, CD-ROM, a magnetic tape, a floppy disk, a light data storage device, and the like. In this embodiment, the information stored in the memory 150 will be described in a context appropriate for each situation.

Further, in the memory 150, map data for the indoor space may be stored. The map data may be input by an external terminal (for example, a user terminal) which exchanges information with the mobile robot 100 through wired or wireless communication or generated by the self-learning of the mobile robot 100.

In the map data, a position of rooms in the indoor space and a position of a target object recognized as an obstacle may be stored. Further, a current position of the mobile robot 100 may be displayed on the map and the current position of the mobile robot 100 may be updated on the map while traveling. In the meantime, when the map data is acquired through the external terminal, in the external terminal, map data same as the map data stored in the memory 150 may be stored.

The map data for the indoor space stored in the memory 150 may be any one of a navigation map used while the mobile robot 100 travels to clean, a simultaneous localization and mapping map (SLAM) used for position recognition, a learning map which stores information when bumping an obstacle to be used for learning-cleaning, a global positioning map used for global positioning recognition, and an obstacle recognizing map in which information about a recognized obstacle is recorded.

In the meantime, as described above, although the map data may be separately stored or managed in the memory 150 for every purpose, the stored map data may not be clearly separated for every purpose.

In the meantime, in the memory 150, a machine learning model which is trained with a data set to which an avoiding mark 200 disposed in a non-driving area of the indoor space where the mobile robot 100 should not travel is labeled may be stored.

In the stored machine learning model, information about the avoiding mark 200 may be stored. For example, information about the avoiding mark 200 has at least any one property of information about an area which is formed with a different color from a color of a floor of the indoor space and information about an area which is formed with a different material from a material of the floor of the indoor space.

The avoiding mark 200 is formed of a tape material to be attached to a periphery of an object (for example, a flower pot, a pet food bowl, a home appliance, furniture, etc.) which is fixed and disposed in the indoor space to be avoided or a moving passage with a sill or a cliff.

Further, the avoiding mark 200 may be stored in the memory 150 as a virtual wall so that the mobile robot 100 cannot move by passing the avoiding mark 200. The avoiding mark 200 which is stored as a virtual wall may be reflected to the map.

When an image corresponding to the information of the avoiding mark 200 is stored in the memory 150 as described above, the learning of the avoiding mark may be performed by a learning unit 152 based on the stored information of the avoiding mark 200.

In the meantime, the learning may be autonomously performed by the mobile robot 100 and may also be performed in the outside rather than the mobile robot 100 and only an avoiding mark model which is deduced as a learning result may be transmitted and stored in the mobile robot 100.

In the embodiment of the present disclosure, an example that the information about the avoiding mark 200 stored in the memory 150 is supplied from an external server (not illustrated) will be described. The server may be a database server which provides big data required to apply various artificial intelligence algorithms and data for speech recognition. The server may include a web server or an application which remotely controls the mobile robot 100 through a communicator (not illustrated) which communicates with an application or a web browser installed in the mobile robot 100.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. Specifically, the machine learning may be a technology for researching and constructing a system for learning, predicting, and improving its own performance based on empirical data and an algorithm for the same. Machine learning algorithms, rather than only executing rigidly-set static program commands, may be used to take an approach that builds models for deriving predictions and decisions from inputted data.

Machine learning paradigms, in which the ANN operates, may include unsupervised learning and supervised learning.

Deep learning, which is a subfield of machine learning, enables data-based learning through multiple layers. Deep learning may represent a set of machine learning algorithms that extract core data from a plurality of data sets as the number of layers in increases.

Deep learning structures may include an artificial neural network (ANN), and may include a convolutional neural network (CNN), a recurrent neural network (RNN), a deep belief network (DBN), and the like. The deep learning structure according to the present embodiment may use various structures well known in the art. For example, the deep learning structure according to the present disclosure may include a CNN, an RNN, a

DBN, and the like. The RNN is widely used in natural language processing, and can be effectively used to process time-series data that changes over time, and may construct an ANN structure by progressively extracting higher level features through multiple layers. The DBN may include a deep learning structure that is constructed by stacking the result of restricted Boltzman machine (RBM) learning in multiple layers. When a predetermined number of layers are constructed by repetition of such RBM learning, the DBN provided with the predetermined number of layers can be constructed. A CNN includes a model mimicking a human brain function, built under the assumption that when a person recognizes an object, the brain extracts the most basic features of the object and recognizes the object based on the results of complex processing in the brain.

Further, the artificial neural network may be trained by adjusting weights of connections between nodes (if necessary, adjusting bias values as well) so as to produce a desired output from a given input. Also, the artificial neural network may continuously update the weight values through learning. Furthermore, methods such as back propagation may be used in training the artificial neural network.

In the meantime, an artificial neural network may be loaded in the mobile robot 100 of an embodiment of the present disclosure and cleaning may be performed by a machine learning-based mobile robot which has input information about the movement obstacle as input data.

In a state when the information about the avoiding mark 200 is stored and learned, the mobile robot 100 travels along the indoor space while sensing a target object in the indoor space and sensing a mark around the target object.

A sensing result sensed by the sensor 120 is transmitted to a receiver 130 and it is determined whether the mark around the target object transmitted to the receiver 130 matches the learned information of the avoiding mark 200.

That is, the sensor 120 senses a mark disposed around the target object through image recognition, electromagnetic wave change, or the like, and determines whether the sensed mark matches the learned information of the avoiding mark 200. Thereafter, when the determined result corresponds to the information of the avoiding mark 200, a traveling route of the mobile robot 100 is reset so that cleaning is performed while avoiding the target object.

In the meantime, in the map data stored in the memory 150, an avoiding mark position where the avoiding mark 200 is disposed may be stored. The avoiding mark position may be stored by transmitting the avoiding mark 200 sensed while the mobile robot 100 travels the indoor space to the external terminal or input in the map data stored in the memory 150 through self-learning.

The stored avoiding mark position may be data which allows the mobile robot 100 to sense the mark around the target object while traveling the indoor space and determine whether the sensed mark around the target object is the avoiding mark 200.

Specifically, the mobile robot 100 senses the mark around the target object while traveling the indoor space and the sensed mark around the target object may not be determined as the avoiding mark 200. In this case, the controller 160 to be described below may determine whether the sensed mark around the target object corresponds to the avoiding mark position stored in the map data.

In this case, when the mark around the target object corresponds to the avoiding mark position stored in the map data, the mark around the target object is determined as the avoiding mark 200 so that the mobile robot 100 can travel while avoiding the avoiding mark 200.

In contrast, when the mark around the target object does not correspond to the avoiding mark position stored in the map data, the sensed mark around the target object may be stored as the avoiding mark position.

Referring to the drawing again, the controller 160 may determine whether the mark around the target object sensed by the sensor 120 is the avoiding mark 200 based on the machine learning model learned by the learning unit 152. In this case, when the mark around the target object is the avoiding mark 200, the controller may determine that the indoor space where the mobile robot 100 travels is a non-driving area and control the driver 140 to allow the mobile robot 100 to travel while avoiding the non-driving area.

Specifically, when a traveling instruction is input to the mobile robot 100, the mobile robot 100 may travel and clean the indoor space. In this case, in the memory 150 of the mobile robot 100, the information of the avoiding mark 200 may be stored. When the mobile robot 100 senses the mark around the target object while traveling and cleaning, the sensed mark around the target object may be compared with the stored avoiding mark 200 information. When it is determined that the sensed mark around the target object matches the stored avoiding mark 200, the controller 160 controls the driver 140 of the mobile robot 100 to travel while avoiding the vicinity of the target object where the avoiding mark 200 is disposed.

Here, the controller 160 may include any types of devices which are capable of processing data such as a processor. Here, ‘the processor’ may, for example, refer to a data processing device embedded in hardware, which has physically structured circuitry to perform a function represented by codes or instructions contained in a program. As one example of the data processing device embedded in the hardware, a microprocessor, a central processing unit (CPU), a processor core, a multiprocessor, an application-specific integrated circuit (ASIC), a field programmable gate array (FPGA), and the like may be included, but the scope of the present disclosure is not limited thereto.

As described above, in the state when the mobile robot 100 learns information about the avoiding mark 200, the avoiding mark 200 which is implemented with a different color and a different material from those of the indoor space is disposed around the target object and when the mobile robot 100 senses the mark while traveling, the mobile robot 100 can travel while avoiding the vicinity of the mark.

Specifically, the avoiding mark 200 is formed by a material such as a tape, so that the avoiding mark 200 can be easily installed in the not-driving area where the mobile robot should not travel and the mobile robot 100 can travel while voiding the non-driving area by the avoiding mark. Therefore, the mobile robot 100 can travel while avoiding an object, a banister, or a cliff which needs to be avoided. Further, the avoiding mark 200 of the embodiment of the present disclosure is disposed in an area to be avoided to allow the avoidance traveling of the mobile robot 100 without installing a separate product in the indoor space.

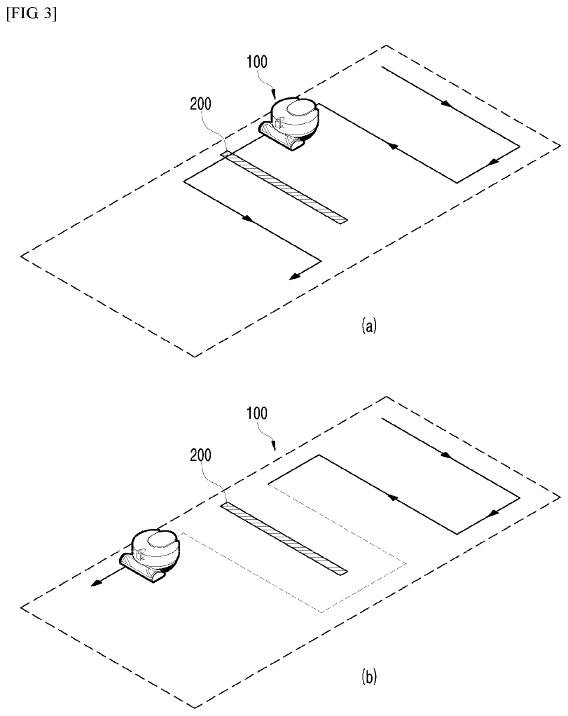

FIG. 3 is a view illustrating an embodiment in which a mobile robot according to an embodiment of the present disclosure senses an avoiding mark while traveling along an indoor space to avoid the avoiding mark. Hereinafter, a description of the common parts previously described with reference to FIGS. 1 and 2 will be omitted.

As illustrated in FIG. 3, in the mobile robot 100, information about the avoiding mark 200 having the similar meaning to an obstacle which needs to be avoided by the mobile robot 100 during the traveling of the mobile robot 100 is learned. The learning information, for example, information about the avoiding mark 200 has at least any one property of information about an area which is formed with a different color from a color of a floor of the indoor space and information about an area which is formed with a different material from a material of the floor of the indoor space.

The avoiding mark 200 is formed of a tape material to be attached to a periphery of an object (for example, a flower pot or a pet food bowl) which is fixed and disposed in the indoor space to be avoided or a moving passage with a sill or a cliff.

In a state the learning information is learned, when a traveling instruction is input to the mobile robot 100, the sensor 120 of the mobile robot 100 senses the target object disposed in the indoor space while moving along the indoor space (see FIG. 3A). When the mark is disposed around the target object sensed by the sensor 120 and the disposed mark is a learned avoiding mark, the mobile robot 100 can change a route to travel along the indoor space or avoid the target object where the avoiding mark 200 is disposed to clean (see FIG. 3B).

Further, when the target object is a target object which needs to be avoided, the mobile robot 100 travels while avoiding the target object so that the damage of the mobile robot may be? caused when the mobile robot travels toward an object which needs to avoid the collision or moves to an area to which the mobile robot 100 cannot move can be prevented.

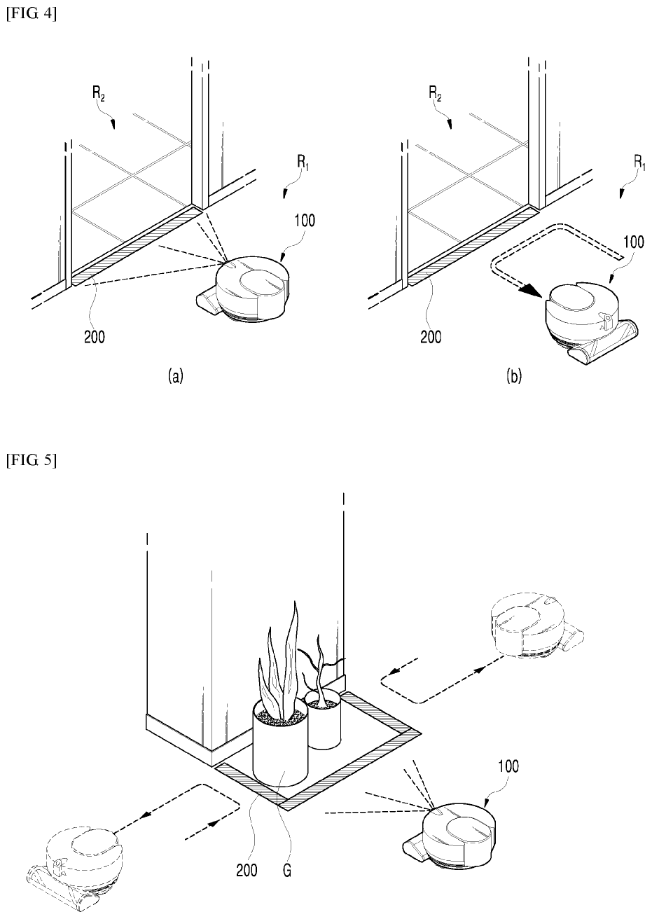

Hereinafter, an embodiment that the sensor 120 of the mobile robot 100 senses and avoids the avoiding mark 200 will be described with reference to FIGS. 4 and 5.

FIGS. 4 and 5 are views schematically illustrating a process of sensing and avoiding an avoiding mark by a mobile robot according to an embodiment of the present disclosure. Hereinafter, a description of the common parts previously described with reference to FIGS. 1 to 3 will be omitted.

Referring to FIG. 4, in the indoor space where the mobile robot 100 travels, an avoiding mark 200 may be disposed on a floor of a moving passage which connects a room 1 R₁ and a room 2 R₂. In this case, there is a sill between the room 1 R₁ and the room 2 R₂, it is difficult for the mobile robot 100 to move from the room 1 R₁ to the room 2 R₂, so that generally, the mobile robot travels by avoiding the sill. To this end, the avoiding mark 200 is disposed in the sill located between the room 1 R₁ and the room 2 R₂. When the avoiding mark 200 is disposed in the sill between the room 1 R₁ and the room 2 R₂, the mobile robot 100 which travels to a position adjacent to the sill may sense the avoiding mark 200 and then change the traveling route of the mobile robot 100 so that the mobile robot 100 performs avoidance-travel.

Further, referring to FIG. 5, a fixed object may be located in the indoor space where the mobile robot 100 travels. For example, the fixed object may include a flower pot, a pet food bowl, home appliances (for example, an air conditioner or a TV), or furniture.

In order to prevent the mobile robot 100 from colliding with the fixed object, the avoiding mark 200 may be disposed in the vicinity of the fixed object. In this case, the user of the mobile robot 100 may recognize an object (see G in FIG. 5) which needs to be avoided while the mobile robot 100 travels later. In this case, before approaching the object G to be avoided by the mobile robot 100, the avoiding mark 200 is disposed around the object to be avoided. Therefore, when the mobile robot 100 is adjacent to the object G to be avoided, the object G to be avoided can be avoided by the avoiding mark 200.

As described above, the avoiding mark 200 is disposed around the object which needs to be avoided during the traveling and cleaning of the mobile robot 100 to allow the mobile robot 100 to avoid the object so that the collision between the object which needs to be avoided and the mobile robot 100 can be prevented in advance.

Further, even though the avoiding mark position where the avoiding mark 200 is disposed is not stored in the map data, the mobile robot 100 which senses the avoiding mark 200 can avoid it?. Therefore, even though it is necessary to set a non-driving area, but the mark is not stored in the map data, the area is immediately marked to be set as a non-driving area.

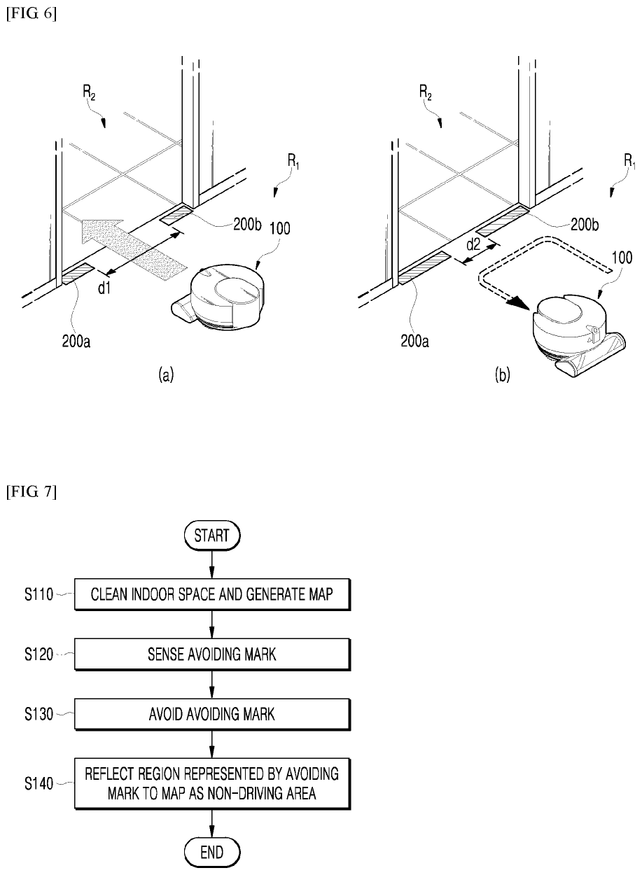

FIG. 6 illustrates an example in which when different avoiding marks are spaced apart from each other while a mobile robot according to an embodiment of the present disclosure avoids the avoiding mark, the mobile robot avoids the avoiding mark or passes between the avoiding marks. Hereinafter, a description of the common parts previously described with reference to FIGS. 1 to 5 will be omitted.

Referring to FIG. 6, in the indoor space where the mobile robot 100 travels, an avoiding mark 200 may be disposed on a floor of a moving passage which connects a room 1 R₁ and a room 2 R₂. In this case, when there is a sill between the room 1 R₁ and the room 2 R₂, it is difficult for the mobile robot 100 to move from the room 1 R₁ to the room 2 R₂, so that generally, the mobile robot travels by avoiding the sill. To this end, the avoiding mark 200 is disposed in the sill located between the room 1 R₁ and the room 2 R₂.

In this case, the avoiding mark 200 to be disposed may include a first avoiding mark 200a and a second avoiding mark 200b, and one end of the first avoiding mark 200a and one end of the second avoiding mark 200b which is spaced apart from the one end of the first avoiding mark 200a may be disposed to be spaced apart from each other. In this case, a distance between the one end of the first avoiding mark 200a and the one end of the second avoiding mark 200b which is spaced apart from the one end of the first avoiding mark 200a and a diameter of the main body 110 of the mobile robot 100 may be compared to determine the avoidance traveling of the mobile robot 100.

Specifically, when the distance (see di of FIG. 6A) between the one end of the first avoiding mark 200a and the one end of the second avoiding mark 200b which is spaced apart from the one end of the first avoiding mark 200a is larger than the diameter of the main body 110 of the mobile robot 100, it is determined that the mobile robot 100 can move between the one end of the first avoiding mark 200a and the one end of the second avoiding mark 200b which is spaced apart from the one end of the first avoiding mark 200a.

Accordingly, the mobile robot 100 can travel between the one end of the first avoiding mark 200a and the one end of the second avoiding mark 200b which is spaced apart from the one end of the first avoiding mark 200a to perform the cleaning.

In contrast, when the distance (see d₂ of FIG. 6B) between the one end of the first avoiding mark 200a and the one end of the second avoiding mark 200b which is spaced apart from the one end of the first avoiding mark 200a is smaller than the diameter of the main body 110 of the mobile robot 100, it is determined that the mobile robot 100 cannot move between the one end of the first avoiding mark 200a and the one end of the second avoiding mark 200b which is spaced apart from the one end of the first avoiding mark 200a. As a result, the mobile robot 100 can travel by avoiding the first avoiding mark 200a and the second avoiding mark 200b.

In this case, in order to determine the distance between the one end of the first avoiding mark 200a and the one end of the second avoiding mark 200b which is spaced apart from the one end of the first avoiding mark 200a and the diameter of the main body 110 of the mobile robot 100, for example, a distance between returning electromagnetic waves after radiating an electromagnetic wave from the sensor 120 of the mobile robot 100 to one end of the first avoiding mark 200a and to one end of the second avoiding mark 200b which is spaced apart from one end of the first avoiding mark 200a can be measured.

To this end, the mobile robot 100 may further include a distance measurer (not illustrated) which can measure a distance. In the embodiment of the present disclosure, even though an example of measuring a distance between the one end of the first avoiding mark 200a and the one end of the second avoiding mark 200b which is spaced apart from the one end of the first avoiding mark 200a using an electromagnetic wave is provided, the present disclosure is not limited to the distance measuring method.

FIG. 7 is a flowchart illustrating of a process of learning an avoiding mark and avoiding the learned avoiding mark by a mobile robot according to an embodiment of the present disclosure. Hereinafter, a description of the common parts previously described with reference to FIGS. 1 to 6 will be omitted.

The mobile robot 100 according to the embodiment of the present disclosure is capable of travelling the indoor space and avoiding the non-driving area where the mobile robot 100 should not travel.

Here, the traveling means the cleaning of an indoor space and the traveling while avoiding the non-driving area means traveling and cleaning while avoiding an area which should not collide with the mobile robot 100 or to which the mobile robot 100 should not move.

In order to allow the mobile robot 100 to avoid the non-driving area, the avoiding mark 200 is disposed around an object G to be avoided (see FIG. 5) in the indoor space. In this case, when the disposed mark corresponds to a machine learning model which is learned in advance by the mobile robot 100, the mark is determined as the avoiding mark 200 to allow the mobile robot 100 to travel while avoiding the object G

Specifically, referring to FIG. 7, before moving the indoor space to clean, the mobile robot 100 receives a data set which is labeled as an avoiding mark and trains the machine learning model for determining whether the mark around the target object sensed while the mobile robot 100 travels is an avoiding mark.

In the stored machine learning model, information about the avoiding mark 200 may be stored. For example, information about the avoiding mark 200 has at least any one property of information about an area which is formed with a different color from a color of a floor of the indoor space and information about an area which is formed with a different material from a material of the floor of the indoor space.

In this case, the trained machine learning model may be stored as an avoiding mark reading program. The avoiding mark 200 which is stored as the avoiding mark reading program is formed of a tape material to be attached to a periphery of an object (for example, a flower pot, a pet food bowl, a home appliance, furniture, etc.) which is fixed and disposed in the indoor space to be avoided or a moving passage with a sill or a cliff.

Thereafter, the mobile robot 100 may generate a map of the indoor space while moving the indoor space to clean in step S110. Next, the mobile robot 100 may travel and sense a mark around the target object in step S120.

When the mark around the target object is sensed, a predetermined electromagnetic wave may be radiated to the mark disposed around the target object. The electromagnetic wave may be any one of an infrared sensor or a laser sensor, but the present disclosure is not limited to a type of radiating wavelength.

Specifically, a laser is radiated to the mark disposed around the target object. When the mark disposed around the target object is formed of a different color and a different material from those of the indoor space, a returning electromagnetic wave time when the laser radiated toward the indoor space returns and a returning electromagnetic wave time which is radiated to the mark disposed around the target object to return may be different. It is determined whether the mark is an avoiding mark based on such a feature.

For example, when the returning electromagnetic time which is radiated to the mark disposed around the target object to return and the returning electromagnetic wave time which is radiated toward an avoiding mark 200 to return are the same, it can be determined that the mark disposed around the target object is an avoiding mark which needs to be avoided by the mobile robot 100.

After sensing the avoiding mark, the region represented by the avoiding mark 200 is recognized as a non-driving area to be avoided and the avoided non-driving area is reflected on the map in steps S130 and S140.

Specifically, when the avoiding mark 200 is avoided, a region represented by the avoiding mark 200 may be recognized as a virtual wall and the region represented by the avoiding mark 200 may be reflected to the map as a virtual wall. The moving robot 100 cannot move by passing the avoiding mark 200 due to the virtual wall.

As described above, when the avoiding mark 200 is reflected to the map, the cleaning route is created based on the map to which the non-driving area is reflected. Or the map of the indoor space to which the non-driving area is reflected may be transmitted to the user terminal to update the current position of the mobile robot 100 on the map.

As described above, in the state the mobile robot 100 learns information about the avoiding mark 200, the avoiding mark 200 which is implemented with a different color and a different material from those of the indoor space is disposed around the target object and when the mobile robot 100 senses the mark while traveling, the mobile robot 100 can travel while avoiding the vicinity of the mark.

The example embodiments described above may be implemented through computer programs executable through various components on a computer, and such computer programs may be recorded on computer-readable media. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present application (especially in the appended claims), the terms “a/an” and “the” include both singular and plural references, unless the context clearly conditions otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. Also, the steps included in the methods according to the present disclosure may be performed through the processor or modules for performing the functions of the step. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Therefore, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof

The present disclosure is thus not limited to the example embodiments described above, and rather intended to include the following appended claims, and all modifications, equivalents, and alternatives falling within the spirit and scope of the following claims.

1. A method for generating a non-driving area of a mobile robot, performed by a processor, the method comprising:
performing cleaning and map generation while moving an indoor space;
sensing an avoiding mark;
recognizing a region represented by the avoiding mark as a non-driving area to avoid; and
reflecting the region represented by the avoiding mark to a map as the non-driving area,
wherein the sensing of an avoiding mark includes determining the avoiding mark through an avoiding mark reading program which is stored in advance.

2. The method for generating a non-driving area of a mobile robot according to claim 1, wherein the sensing includes:
radiating a predetermined electromagnetic wave to the sensed mark;
measuring the electromagnetic wave reflected by the mark; and
determining whether the mark is the avoiding mark based on the measurement of the reflected electromagnetic wave.

3. The method for generating a non-driving area of a mobile robot according to claim 2, wherein the determining includes:
analyzing the electromagnetic wave reflected from the mark and determining the mark as the avoiding mark when it is determined that the mark has at least any one property of a different color or a different material from those of another driving area of the indoor space.

4. The method for generating a non-driving area of a mobile robot according to claim 1, further comprising:
before the performing of cleaning and map generation,
a learning data inputting step of receiving a learning data set including a specific image and a label indicating that the specific image is the avoiding mark;
a training step of training a machine learning model for determining whether a target sensed during the traveling of the mobile robot is the avoiding mark based on the learning data set; and
a step of storing the machine learning model generated by the training step as the avoiding mark reading program.

5. The method for generating a non-driving area of a mobile robot according to claim 1, wherein the avoiding includes recognizing the region represented by the avoiding mark as a virtual wall and
wherein the reflecting to a map includes reflecting the region represented by the avoiding mark to the map as the virtual wall.

6. The method for generating a non-driving area of a mobile robot according to claim 1, further comprising:
after the reflecting to a map,
generating a cleaning route based on the map to which the non-driving area is reflected.

7. The method for generating a non-driving area of a mobile robot according to claim 1, further comprising:
after the reflecting to a map,
transmitting the map of the indoor space to which the non-driving area is reflected to a user terminal;
receiving a user confirmation signal for the map of the indoor space; and
storing the map of the indoor space based on the user confirmation signal.

8. A computer readable recording medium in which a computer program which executes the method according to claim 1 using a computer is stored.

9. A mobile robot which travels while avoiding a non-driving area; the mobile robot comprising:
a main body of the mobile robot;
a driver configured to allow the main body to travel;
a sensor equipped in the main body, the sensor sensing a generated avoiding mark while moving an indoor space;
a memory configured to store map data of a space where the mobile robot travels; and
a controller configured to control the memory, the driver, the sensor, and the mobile robot;
wherein the controller is configured to determine whether a target sensed by the sensor is the avoiding mark through an avoiding mark reading program which is stored in advance, recognize a region represented by the avoiding mark as the non-driving area when the sensed target is the avoiding mark and control the driver to avoid the non-driving area, and reflect the region represented by the avoiding mark to the map data as the non-driving area.

10. The mobile robot according to claim 9, wherein the sensor is capable of radiating a predetermined electromagnetic wave toward the sensed mark.

11. The mobile robot according to claim 10, wherein the controller measures an electromagnetic wave reflected by the mark and determines whether the mark is the avoiding mark based on measurement of the reflected electromagnetic wave.

12. The mobile robot according to claim 11, wherein the controller analyzes the electromagnetic wave reflected from the mark and determines the mark as the avoiding mark when it is determined that the mark has at least any one property of a different color or a different material from those of another driving area of the indoor space.

13. The mobile robot according to claim 9, wherein the controller trains a machine learning model for determining whether the target sensed during the traveling of the mobile robot is the avoiding mark based on a learning data set input by including a specific image and a label indicating that the specific image is the avoiding mark, and stores the trained machine learning model in the memory as the avoiding mark reading program.

14. The mobile robot according to claim 13, wherein the controller is configured to recognize the region represented by the avoiding mark as a virtual wall and reflect the region represented by the avoiding mark to the map data stored in the memory as the virtual wall.

15. The mobile robot according to claim 9, wherein the controller is further configured to generate a cleaning route of the mobile robot based on the map data to which the non-driving area is reflected.

16. The mobile robot according to claim 9, further comprising:
a communicator configured to communicate with a user terminal,
wherein the controller is further configured to transmit the map data to which the non-driving region is reflected to the user terminal through the communicator and store the map data in the memory based on a user confirmation signal after receiving the user confirmation signal for the map data.
